(19) United States
(12) Patent Application Publication
(10) Pub. No.: US 2025/0106358 A1
(43) Pub. Date: Mar. 27, 2025

(54) CONTROL METHOD FOR CONTROL OF A VIRTUAL PANEL DISCUSSION OVER A COMMUNICATION LINK BETWEEN A PLURALITY OF COMMUNICATION PARTICIPANTS

(71) Applicant: Heinlein Support GmbH, Berlin (DE)

(72) Inventors: Peer HEINLEIN, Berlin (DE); Dennis KALBHEN, Potsdam (DE); Frederik SCHWAN, Darmstadt (DE)

(73) Assignee: Heinlein Support GmbH, Berlin (DE)

(21) Appl. No.: 18/728,484

(22) PCT Filed: Jan. 12, 2023
(86) PCT No.: PCT/DE2023/200011

§ 371 Date: Jul. 12, 2024

(30) Foreign Application Priority Data
Jan. 14, 2022 (DE) 10 2022 200 416.7

(51) Int. Cl. H04N 7/15; H04N 7/14

(52) U.S. Cl. CPC H04N 7/157; H04N 7/147

(57) ABSTRACT

The present invention relates to a control method for controlling a virtual panel discussion via a communication link (CL) between a plurality of communication participants (CP), comprising the following steps:
registering at least one communication participant (CP) of the communication link (CL) in a role as a panel communication participant (PCP),
registering a plurality of other communication participants (CP) in a role as audience communication participant (ACP),
applying a panel communication profile (PCPr) for the communication link (CL) of the at least one panel communication participant (PCP),
applying an audience communication profile (ACPr), which is different from the panel communication profile (PCPr), for the communication link (CL) of the audience communication participants (ACP),
controlling communication parameters (CPA) of the communication link (CL) based on the applied panel communication profiles (PCPr) and the applied audience communication profiles (ACPr).

The present invention relates to a control method for controlling a virtual panel discussion via a communication link between a plurality of communication participants and a computer program product for carrying out such a control method.

It is known for a communication link to be established between communication participants. This usually happens in the context of video conferences, so that two or also significantly more communication participants can exchange ideas with each other. It is also known for webinars to be held in so-called streams, i.e. for example one or more communication participants of the webinar present this and make their video and audio signal available to individual communication participants as a downstream.

A disadvantage of the known solutions is that a multi-directional communication link has not in the past been able to distinguish between different roles of the communication participants, in particular in a flexible way. In particular, it has not in the past been possible, via the known communication links, to simulate virtual panel discussions in which the panel participants account for the main part of the communication, while audiences can at least partially intervene in the panel discussion.

It is therefore the object of the present invention to remedy, at least in part, the disadvantages described above. In particular, it is the object of the present invention to enable a virtual simulation of a real panel discussion via a communication link in a cost-effective and simple manner.

The above object is achieved by a control method with the features of claim 1 and a computer program product with the features of claim 14. Further features and details of the invention are disclosed in the dependent claims, the description and the drawings. Naturally, features and details which are described in connection with the control method according to the invention also apply in connection with the computer program product according to the invention and vice versa, so that with regard to disclosure mutual reference is or can always be made to the individual aspects of the invention.

According to the invention, a control method is proposed for controlling a virtual panel discussion via a communication link between a plurality of communication participants. Such a control method comprises the following steps:
registering at least one communication participant of the communication link in a role as a panel communication participant,
registering a plurality of other communication participants in a role as audience communication participant,
applying a panel communication profile for the communication link of the at least one panel communication participant,
applying an audience communication profile, which is different from the panel communication profile, for the communication link of the audience communication participants,
controlling communication parameters of the communication link based on the applied panel communication profiles and the applied audience communication profiles.

A method according to the invention is based on the idea that individual communication participants of a communication link can be assigned different roles. These roles can correspond to real role assignments in a real panel discussion, which are to be simulated virtually. In the simplest case, a panel discussion in the sense of the present invention can also be an event with only a single person on the panel. Such an embodiment of a panel discussion can also be described as a special case in the form of a teaching or lecture event. The essential roles available are those of the panel discussion participants as panel communication participants and those of the audience members as audience communication participants. According to the invention, the communication participants of the communication link are now divided into at least these two different roles and, accordingly, a role corresponding to the respective specific communication participant is registered, preferably for all communication participants. However, in addition to their purely informative nature, regarding the function of the communication participants and the functional differentiation between these, these roles are provided with different communication profiles. The communication profiles are, as will be explained later, coupled with control functions for the control of communication parameters based on these communication profiles. In addition to registering the role of the respective communication participant, the corresponding communication profile is then applied on the basis of the registered role. This ensures that the role function assumed from the reality of the panel discussion and the associated need for different types of communication within the framework of the respective communication profile is also reflected, in the virtual panel discussion, in the control of the communication parameters of the communication link through the application of these communication profiles.

This abstract concept becomes clear, in particular, when it is explained in more detail in the following by means of an example. For example, panel participants can and should conduct a plurality of communication types. In addition to a purely unidirectional communication in the form of a presentation to the audience, a panel discussion usually also requires communication between the panel participants, in particular if at least two panel communication participants are registered; to provide a better explanation, the invention is explained below by means of examples of at least two panel communication participants. However, these also include the variant of a panel presentation with only a single panel communication participant. Accordingly, the panel communication profile can form a video exchange between the panel participants and from the panel participants, unidirectionally, to the audience communication participants. Accordingly, the audio information between the panel communication participants can also be bidirectional, and unidirectional from all panel communication participants to the audience communication participants. In addition, in a panel discussion it is usually the case that the audience does not intervene in the course of the panel discussion, or only to a very limited extent. The audience communication profile is for example preferably designed in such a way that no audio transmission can take place from the individual audience communication participants and/or no video transmission can take place from the individual audience communication participants. These are defined for passive listening and passive watching. Optionally, the audience communication participants can intervene in the panel discussion and/or contact the panel communication participants via text message. This can also be understood as a chat or messaging function.

In other words, it is now possible, by very simple technical means, to set up a known communication link, for example in the context of a video conferencing system, in the familiar way but, by means of the defined profile specification of communication profiles, to specify defined and specific communication profiles for individual communication participants on the basis of their registered role, which in this way allow a simple simulation of a real panel discussion, above all with low computational effort. The specified communication profiles are in particular predefined and can be applied automatically based on the defined and explained roles. In principle, it is immaterial whether the roles for the communication participant are registered before the start of the communication link, during the start of the communication link, or in the form of a change during the course of the communication link. Also, as will also be explained in more detail later, a change, in particular a temporary change, of roles of the communication participant can take place during the course of the communication link.

It can be advantageous if, in a control method according to the invention, the panel communication profile has at least one of the following settings for the communication parameters of the communication link:
display of the video images in the foreground as an active communication participant
display of the video images in a fixed position and/or graphically highlighted
transmission of audio information in the foreground
highlighting of the speaker, in particular through graphic marking.

The above list is a non-exhaustive list. The display of the video images in the foreground and/or in a fixed position can be related to the respective display device on a participant device. The communication profile can also provide for different display variants for different participant roles. For example, as panel communication participants, the panel participants can receive a different display on their own participant device than the normal audience communication participants. However, the panel discussion becomes easier to follow, in particular for the audience communication participants, in that the video images of the panel communication participants are always displayed in the foreground, for example graphically highlighted, in particular in the form of a symbolically suggested stage, and preferably in a fixed position relative to each other on the display device of the participant devices. The audio information is also transmitted preferentially by all panel communication participants jointly to the audience of audience communication participants. In order to make it even easier for the audience communication participants to follow the panel discussion, the active speaker of the panel communication participants can in addition be highlighted on the display device of the participant devices. This can be done, for example, with a frame or a similar visual effect.

Further advantages can be achieved if, in a control method according to the invention, the audience communication profile has at least one of the following settings for the communication parameters of the communication link:
suppression of a transmission and/or display of the video images
suppression of a transmission and/or playback of the audio information.

The above list is also a non-exhaustive list. While a communications network would in principle allow classic bidirectional communication transmissions for such a communication link, audio and video signals in particular can be suppressed. In the simplest case, this leads to the audience communication participants' camera being turned off and/or the audience communication participants' microphones being set to “mute”. In particular, this is done in a combined way. In addition to simply blocking the transmission of the audio information and/or the video images to other communication participants, the method according to the invention can in principle already block their transmission starting out from the participant device of the respective audience communication participant. In addition to complete blocking, a reduction in the data to be transmitted, for example with reduced video quality, is also conceivable. Since, due to the audience communication profile, neither the video images nor the audio information can be sent to other communication participants during the further course of the control method, these would represent unnecessary ballast in the communication link. Thus, suppressing these at the respective participant device of the audience communication participant can reduce the bandwidth of the communication link and thus improve the quality of the communication link.

Further advantages can be achieved if, in a control method according to the invention, at least one of the following communication parameters of the communication link is controlled:
video transmission of a communication participant,
arrangement of a video image of a communication participant on a communication playback on the participant devices of the communication participants
audio transmission of a communication participant
text transmission of a communication participant.

The above list is a non-exhaustive list. Preferably, several communication parameters are taken into account in parallel for control purposes. For example, it is also possible that chat functions are influenced during text transmission, so that some roles of the communication participants have chat access and others do not. Furthermore, limited chat access, for example in the form of a moderated chat, is also conceivable. Special and separate chat rooms that are not visible to the other roles of the communication participants may also be provided for individual roles of the communication participants. The individual communication parameters are in particular based on corresponding setting values of the communication profiles for all roles of the communication participants. Each communication profile can have different framework conditions, explicit specified values or specified areas for each role of a communication participant which must be complied with when controlling the communication link in the form of the communication parameters for this specific communication participant. Here, it can once again clearly be seen how simply the assignment of the communication profiles based on the role functions of the communication participants makes possible the specific controllability of the panel discussion in the communication link.

It can bring further advantages if, in a control method according to the invention, the panel communication profile has an equalisation specification to equalise an audio parameter and/or a video parameter of the panel communication participants. Since the panel communication participants can transmit their audio information and/or their video information to all audience communication participants, in particular all at the same time or substantially at the same time, and in particular can also speak or respond to each other at the same time, differences in volume and/or image quality are very clearly apparent to the audience communication participants. Therefore, in this embodiment, an equalisation specification can be specified which is in the form of either an absolute equalisation specification or a relative equalisation specification. In relative terms, the loudest panel communication participant can for example be compared with the quietest communication participant and an average or other specified value for the transmitted volume of all panel communication participants can be determined. An absolutely necessary volume can also be specified for the panel communication participants, so that all panel communication participants are transmitted to the audience communication participants at an identical or substantially identical volume, regardless of their microphone quality in the respective recording situation. In addition to the volume, it is also possible to equalise other audio parameters such as frequency adjustments, noise reduction or the like. In addition or alternatively, corresponding video information can also be adjusted. For example, brightness, contrast, predefined background images or the like can be equalised between the individual panel communication participants, so that differences in camera quality are also compensated for and in this way an image that is as equalised and consistent as possible is provided for all audience communication participants for all panel communication participants, even if these provide different signal qualities for the communication link due to different participant devices.

Further advantages can be achieved if, in a control method according to the invention, all communication participants who have not been registered as panel communication participants are registered in the role of audience communication participant. In particular, after the panel communication participants have been assigned and registered as such, all remaining communication participants are automatically registered as audience communication participants. Since, in panel discussions, the special roles in the form of panel participants, but also in the form of a moderator communication participant or the like, are usually clearly limited in number, and the audience communication participants represent the majority of communication participants, this embodiment further simplifies the control method. The greatest number of all communication participants is often the number of audience communication participants who, in this embodiment, are automatically registered, without the need for additional assignment or manual processing of the remaining communication participants. In addition to the reduced computational effort required, this also increases the speed of setting up the panel discussion using a control method according to the invention. Flexible operation with an unknown number of audience communication participants is also conceivable.

It can bring further advantages if, in a control method according to the invention, at least one communication participant of the communication link is registered in a further role, with an application of a communication profile specific to this role, in particular in one of the following:
active question communication participant with an active question communication profile,
passive question communication participant with a passive question communication profile,
moderator communication participant as moderator of the panel discussion with a moderator communication profile.

The above list is also a non-exhaustive list. The individual communication participant roles differ in the simulated role of the individual communication participants which occur in a real panel discussion. Preferably, a communication participant can only be registered with a single role during the course of the communication link. In the course of a panel discussion, it may happen that an audience communication participant wants to comment on the panel discussion or wants to address a question to the panel communication participants. In such a case, an audience communication participant can for example be provided, at least temporarily, with an active question communication profile by a moderator communication participant in that they are registered as an active question communication participant with a preferably temporary role registration. The active question communication profile allows bidirectional communication, in particular the sending of the audio and video signal of the active question communication participant to the other audience communication participants and to the panel communication participants. After a question has been asked or after a comment, it is often common for the question communication participant to remain visible, and for his reactions to his comment and/or the answer to his question to be of interest to the other audience communication participants. However, in such a case an intervention in the form of further questioning by the question communication participant is often no longer desirable, so that they have now been provided with a passive question communication profile, for example as a passive question communication participant. Their video signal is still transmitted to all audience communication participants and also to the panel communication participants, but no further audio transmission is enabled. In order to enable the smoothest possible procedure, in particular with regard to the question situations described above, one of the panel communication participants, but also another communication participant, may be appointed as moderator of the panel discussion in the form of a moderator communication participant. Their moderator communication profile can in addition include authorisations, for example to adapt communication profiles, but also to change roles of different communication participants or to re-assign or register these. For example, the moderator can mute all audience communication participants, change the positions of video displays, adjust audio and video balancing specifications or the like.

In the case of a control method according to the preceding paragraph, it may be advantageous if the registration of another role for at least one communication participant is temporary and this communication participant is registered again in their previous role, in particular before the end of the communication link. This applies in particular to the steps relating to the role of the active question communication participant and the subsequent passive question communication participant explained in the previous paragraph. For example, the temporary registration can be coupled with a defined period of time, so that, for example after 30 seconds of being able to ask questions, an active question communication participant is automatically redefined as a passive question communication participant and registered accordingly. Variable information, for example a defined pause length in an audio signal of the active question communication participant, can also be used flexibly for such a redefinition of the role registration for the communication participant.

Further advantages can be achieved if, in a control method according to the invention, the registered role of the communication participants is displayed in a participant list of the communication link. This takes place in particular on all participant devices and thus for all communication participants, so that all communication participants know, in particular, at least their own role function, but preferably also the role function of all other communication participant. This also applies in particular to temporarily assigned roles such as the active question communication participant and/or the passive question communication participant.

It is also advantageous if, in a control method according to the invention, a separate chat room is set up as part of the communication link for at least one role of the communication participant. A chat room represents the possibility of a text link between individual communication participants, so that they can write text messages to each other in this chat room. In addition to a messaging possibility from one communication participant to another communication participant, which can also be referred to as a specific messaging function, a chat room can generally be viewed by several communication participants. For example, with this embodiment it is now possible to use such a separate chat room for the panel communication participants, so that these can exchange information with each other in writing without the audience communication participants being aware of this. Thus break announcements, consultations or other forms of coordination among the panel communication participants, for example, are possible.

It can bring further advantages if, in a control method according to the invention, the steps of registration are at least partially carried out before the start of the communication link. This can also be understood as setting up the panel discussion in a virtual way. In particular, this applies to the registration of the panel communication participants and in particular also of a moderator communication participant. For this setting-up, the assigned role can already be communicated in the invitation to different communication participants. In principle, it is also conceivable that, depending on the participant role of the communication participant in the corresponding invitation, a distinction is already communicated in the dial-in link, depending on which role is to be registered for the communication link for the associated communication participant.

It can bring further advantages if, in a control method according to the invention, at the end of the panel discussion, the communication link to all audience communication participants is terminated and is maintained for the remaining panel communication participants. This can allow an automatic debriefing at the panel level, so that there is no need to set up a subsequent video conference between the panel communication participants manually. Rather, it is ensured that all communication participants who are not admitted to this debriefing, i.e. in particular all communication participants who do not belong to a defined group in the form of the panel communication participants and, in particular, also the moderator communication participant, are separated from the communication link, preferably automatically, and thus a secure debriefing can be guaranteed.

It brings further advantages if, in a control method according to the invention, in addition the communication profiles also have display parameters for a display specific to the respective role on the corresponding participant device of the communication participant. These can be default settings which can in particular also be adapted on individual participant devices by individual communication participants specifically according to their own wishes. These can also be used to display messages, for example to display the chat room already explained, a question chat between moderator communication participant and audience communication participants or similar only to the individual communication participants intended to receive these.

A further subject matter of the present invention is a computer program product comprising commands which, when the program is run on a computer, cause this to carry out the steps of a control method according to the invention.

Further advantages, features and details of the invention are explained in the following description, in which embodiments of the invention are described in detail with reference to the drawings. The features mentioned in the claims and in the description may in each case be essential to the invention individually or in any combination. In each case schematically:

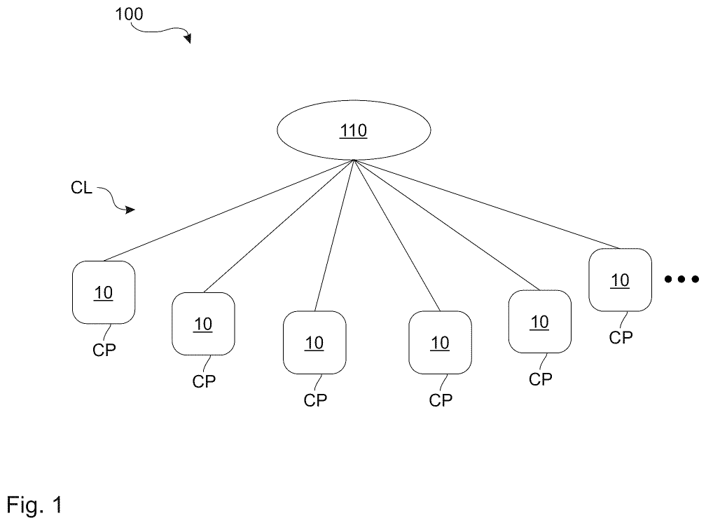

FIG. 1 shows an embodiment of a communications network for carrying out a control method according to the invention,

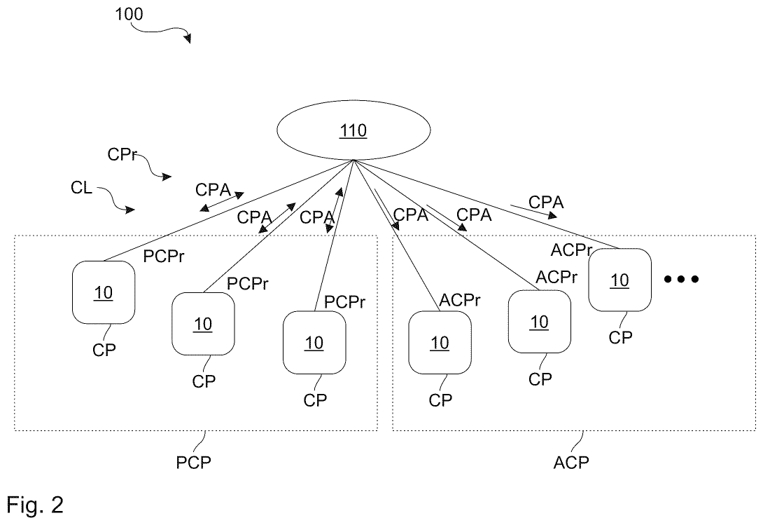

FIG. 2 shows the communications network of FIG. 1 in a first variant of a control method,

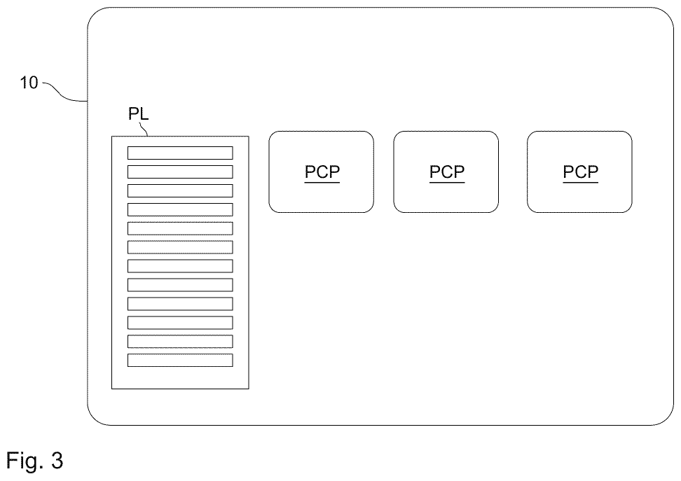

FIG. 3 shows the embodiment of FIG. 2 when displayed on a participant device,

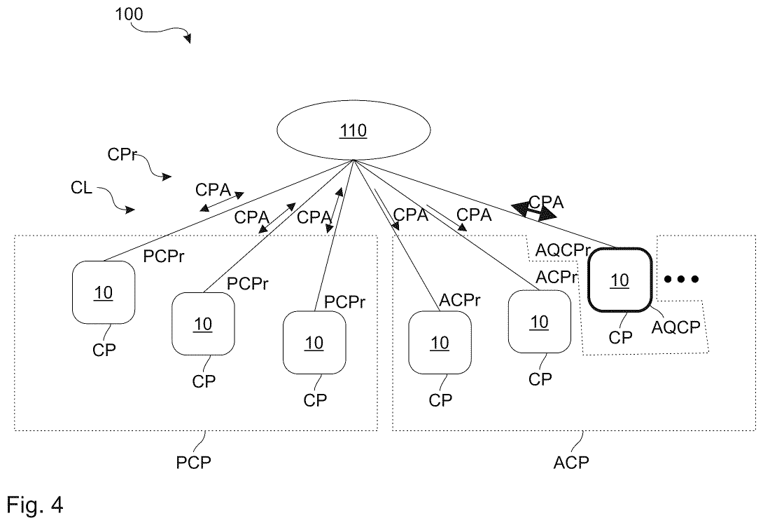

FIG. 4 shows the communications network of FIG. 1 in another variant of a control method,

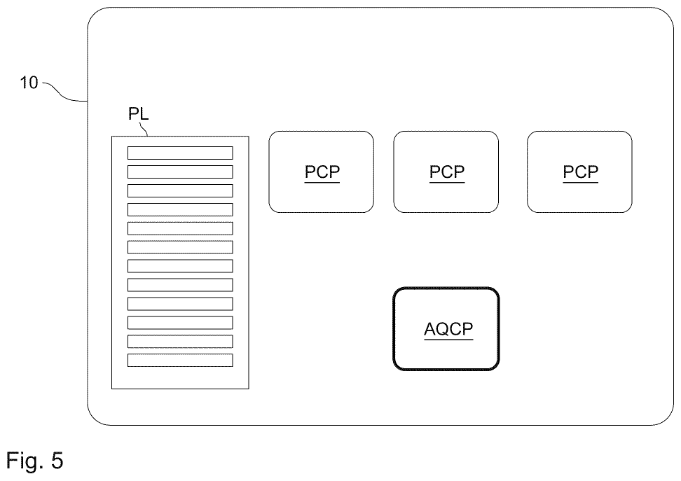

FIG. 5 shows the embodiment of FIG. 4 when displayed on a participant device,

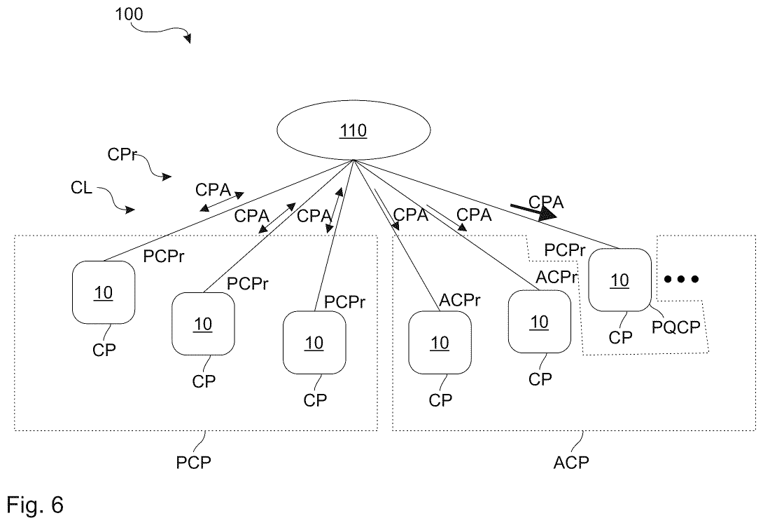

FIG. 6 shows the communications network of FIG. 1 in another variant of a control method,

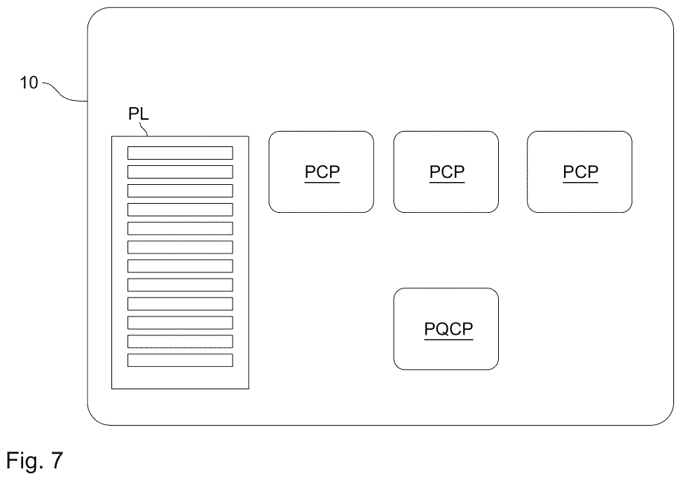

FIG. 7 shows the embodiment of FIG. 6 when displayed on a participant device,

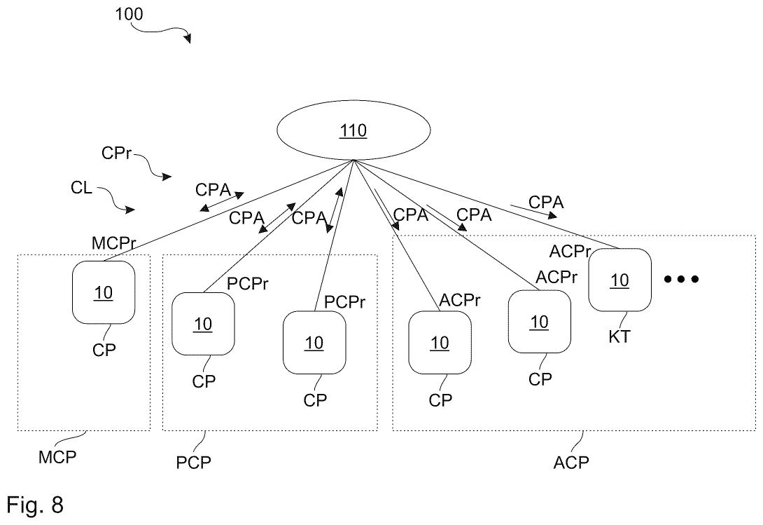

FIG. 8 shows the communications network of FIG. 1 in another variant of a control method,

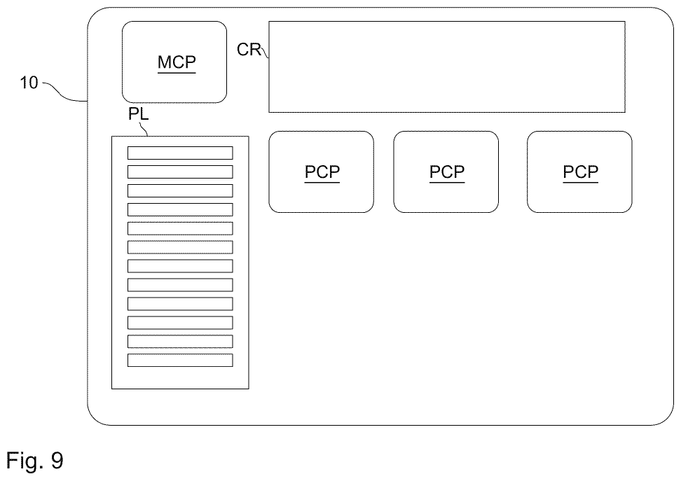

FIG. 9 shows the embodiment of FIG. 8 when displayed on a participant device, and

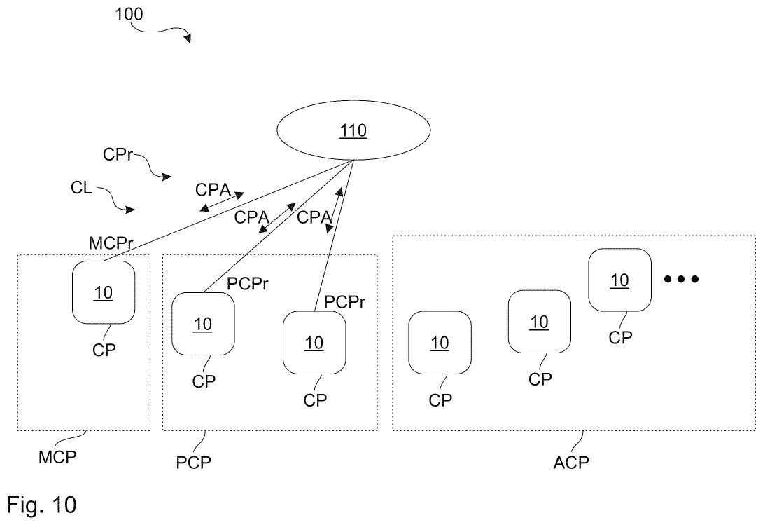

FIG. 10 shows the communications network of FIG. 1 in another variant of a control method.

FIG. 1 shows schematically a communications network 100 which here enables a communication link CL via a communications server 110. The communication participants CP are all equipped here with a participant device 10, which can be a mobile phone, a tablet computer, a desktop computer, a laptop or the like. The individual participant devices 10 are connected to the communications server 110 via wired or wireless means of communication, so that the communication link CL can be established in the manner shown in FIG. 1. While FIG. 1 schematically represents six different participant devices 10, the three points indicated on the right indicate an unspecified increase in the number of participants and the number of communication participants CP and thus corresponding to the number of participant devices 10.

To carry out a control method according to the invention, in a first step the roles for the individual communication participants CP are registered. FIG. 2 shows the result of this registration. Here, three communication participants CP on the left are defined as panel communication participants PCP with a dotted-line frame. All other communication participants CP on the right, in particular the unspecified further communication participants CP represented by the three dots, are registered and defined here as audience communication participants ACP. This registering of the role of the individual communication participants CP meant that corresponding communication profiles CPr could also be assigned and applied to the individual communication participants CP. Here, the panel communication participants PCP bring the panel communication profiles PCPr with them. The result of this is that, by applying the panel communication profiles PCPr to the communication parameters CPA, the panel communication participants PCP establish a bidirectional audio and video connection to the communications server 110.

For the audience communication participants ACP in FIG. 2, audience communication profiles ACPr have been specified and applied accordingly for all communication participants CP of this role definition. In the application through control of the communications server 110, this leads to the communication parameters CPA in the communication link CL having been adapted to these audience communication participants ACP in such a way that they have been set exclusively as receivers for the audio and video signals of the panel communication participants PCP. In other words, they receive the audio and video information of all panel communication participants PCP in the form of a stream.

It can clearly be seen here that no detailed assignment of individual communication parameters CPA to individual communication participants CP is necessary. Rather, the roles of the individual communication participants CP can be registered in groups, and the limit values and specifications for the communication parameters CPA stored through the communication profiles CPr assigned to the respective group can be fulfilled for all communication participants CP of the respective role group.

FIG. 3 shows schematically how a situation as shown in FIG. 2 can look on a participant device 10. Here, the video image can be seen on the display, for example in the form of a tablet computer, for an audience communication participant ACP. The three panel communication participants PCP can be seen with video and audio signal on the display of the participant device 10 and can also be heard via the audio output. A participant list PL shows at least the panel communication participants PCP, but preferably all communication participants CP.

FIG. 4 shows another variant that starts out from FIG. 3. FIG. 4 shows a specific situation during the course of a communication link CL in the form of a panel discussion. For example, it may be possible that one of the audience communication participants ACP would like to address a question or comment to the panel communication participants PCP. For this purpose, they are temporarily assigned a different role, for example by the moderator communication participant MCP, which will be explained later, and registered for them. In FIG. 4, this is the role of the active question communication participant AQCP. As a result of this role change, the corresponding communication profile CPr of the communication participant CP also changes to the active question communication profile AQCPr. This leads to the communication parameters CPA being adapted in line with this change and bidirectional audio and video communication is possible for this communication participant CP as the active question communication participant AQCP. Similarly, FIG. 5 shows a display on a participant device 10 for this situation. The active question communication participant AQCP is now not only integrated via their audio signals, but also via their video signal, and is shown, preferably not only to the panel communication participants PCP, but also to the other audience communication participants ACP, on the display of their participant devices 10.

As soon as the active question communication participant AQCP has asked the question, it is usually no longer necessary to transmit their audio information. However, it may be interesting to share their reaction visually with the audience communication participants ACP. FIG. 6 shows this redefinition of a new role assignment, so that this communication participant CP is now defined and registered as a passive question communication participant PQCP. Accordingly, they are now assigned a passive question communication profile PQCPr as a new communication profile CPr, so that they can only serve as a receiver in terms of the audio signals, but as a transmitter and receiver with regard to their video signals. FIG. 7 shows this representation, in that the passive question communication participant PQCP is now still displayed on all participant devices 10 of all audience communication participants ACP, but their image is no longer highlighted with a bold border, so that they are no longer marked as an active speaker, but only as an audience member.

FIG. 8 shows a variant in which an additional role has been introduced. Thus, a moderator communication participant MCP has been registered here, to the left of the now only two panel communication participants PCP. As already explained in the introduction, within the framework of the present invention, a panel discussion can also be conducted as a lecture presentation with a single panel communication participant PCP. The latter is assigned a moderator communication profile MCPr and is also connected to the communications server 110 with bidirectional communication as communication parameter CPA. In particular, they can have additional functions and, for example, role assignments, preferably for the audience communication participants ACP. A corresponding display is shown, for example, in FIG. 9. Here, the moderator communication participant MCP is shown in the upper left corner in an additional video transmission. In addition, FIG. 9 also shows that a single chat room CR can be provided. This FIG. 10 shows the display on a participant device 10 of a panel communication participant PCP or on the participant device 10 of the moderator communication participant MCP. The chat room CR is a chat room CR intended only for the panel communication participants PCP and the moderator communication participant MCP, so that they can communicate with each other by text via this specific chat room CR without having to share this information with all other audience communication participants ACP.

FIG. 10 shows another variant after the end of this panel discussion. It is often desired that after the end of the panel discussion, the panel communication participants PCP and in this case also the moderator communication participant MCP exchange ideas in a debriefing. In this embodiment, this leads to the communication link CL being disconnected for all audience communication participants ACP. For the panel communication participants PCP and the moderator communication participant MCP, the communication link CL is maintained and the debriefing can take place after the panel discussion in a secure and, above all, automatically established manner.

The above explanation of the embodiments describes the present invention exclusively in the context of examples. Of course, individual features of the embodiments can be combined with each other freely, where technically expedient, without departing from the scope of the present invention.

### LIST OF REFERENCE SIGNS

10 participant device
100 communications network
110 communications server
CL communication link
CP communication participant
PCP panel communication participant
ACP audience communication participant
AQCP active question communication participant
PQCP passive question communication participant
MCP moderator communication participant
CPr communication profile
PCPr panel communication profile
ACPr audience communication profile
AQCPr active question communication profile
PQCPr passive question communication profile
MCPr moderator communication profile
CPA communication parameter
PL participant list
CR chat room

1. Control method for controlling a virtual panel discussion via a communication link (CL) between a plurality of communication participants (CP), comprising the following steps:
registering at least one communication participant (CP) of the communication link (CL) in a role as a panel communication participant (PCP),
registering a plurality of other communication participants (CP) in a role as audience communication participant (ACP),
applying a panel communication profile (PCPr) for the communication link (CL) of the at least one panel communication participant (PCP),
applying an audience communication profile (ACPr), which is different from the panel communication profile (PCPr), for the communication link (CL) of the audience communication participants (ACP),
controlling communication parameters (CPA) of the communication link (CL) based on the applied panel communication profiles (PCPr) and the applied audience communication profiles (ACPr).

2. Control method according to claim 1, wherein the panel communication profile (PCPr) has at least one of the following settings for the communication parameters (CPA) of the communication link (CL):
display of the video images in the foreground as an active communication participant
display of the video images in a fixed position and/or graphically highlighted
transmission of audio information in the foreground
highlighting of the speaker, in particular through graphic marking.

3. Control method according to claim 1, wherein the audience communication profile (ACPr) has at least one of the following settings for the communication parameters (CPA) of the communication link (CL):
suppression of a transmission and/or display of the video images
suppression of a transmission and/or playback of the audio information.

4. Control method according to claim 1, wherein at least one of the following communication parameters (CPA) of the communication link (CL) is controlled:
video transmission of a communication participant (CP)
arrangement of a video image of a communication participant (CP) on a communication playback on the participant devices (10) of the communication participants (CP)
audio transmission of a communication participant (CP)
text transmission of a communication participant (CP).

5. Control method according to claim 1, wherein the panel communication profile (PCPr) has an equalisation specification to equalise an audio parameter and/or a video parameter of the panel communication participants (PCP).

6. Control method according to claim 1, wherein all communication participants (CP) who have not been registered as panel communication participants (PCP) are registered in the role of audience communication participant (ACP).

7. Control method according to claim 1, wherein that at least one communication participant (CP) of the communication link (CL) is registered in a further role with an application of a communication profile (CPr) specific to this role, in particular in one of the following:
active question communication participant (AQCP) with an active question communication profile (AQCPr)
passive question communication participant (PQCP) with a passive question communication profile (PQCPr)
moderator communication participant (MCP) as moderator of the panel discussion with a moderator communication profile (MCPr).

8. Control method according to claim 7, wherein the registration of an additional role for at least one communication participant (CP) is temporary and this communication participant (CP) is registered again in their previous role, in particular before the end of the communication link.

9. Control method according to claim 1, wherein the registered role of the communication participants (CP) is displayed in a participant list (PL) of the communication link (CL).

10. Control method according to claim 1, wherein a separate chat room (CR) is set up as part of the communication link (CL) for at least one role of the communication participants (CP).

11. Control method according to claim 1, wherein the steps of registration are at least partially carried out before the start of the communication link (CL).

12. Control method according to claim 1, wherein at the end of the panel discussion, the communication link (CL) to all audience communication participants (ACP) is terminated and is maintained for the remaining panel communication participants (PCP).

13. Control method according to claim 1, wherein in addition the communication profiles (CPr) also have display parameters for a display specific to the respective role on the corresponding participant device (10) of the communication participant (CP).

14. Computer program product comprising commands which, when the program is run on a computer, cause the computer to carry out the steps of a control method having the features of claim 1.
